(19) United States
(12) Patent Application Publication
(10) Pub. No.: US 2026/0017647 A1
(43) Pub. Date: Jan. 15, 2026

(54) MANAGING INSIGHTS FOR DATA TRANSACTIONS

(71) Applicant: Motorola Mobility LLC, Chicago, IL (US)

(72) Inventors: Krishnan Raghavan, Bangalore (IN); Nakul Patel, Bangalore (IN)

(73) Assignee: Motorola Mobility LLC, Chicago, IL (US)

(21) Appl. No.: 18/769,218

(22) Filed: Jul. 10, 2024

(51) Int. Cl. G06Q 20/38

(52) U.S. Cl. CPC G06Q 20/386; G06Q 20/389

(57) ABSTRACT

Techniques for managing insights for data transactions are described and are implementable to manage various aspects of multi-condition data transactions. For instance, a transaction management service is implementable by a client device to detect that a data transaction includes a pending resource transfer reversal condition. Responsive to the detection, the transaction management service can generate a data transaction insight based on the pending resource transfer reversal condition. The transaction management service is further implementable to monitor a status of the pending resource transfer reversal condition and generate alerts and/or notifications based on the monitored status.

### BACKGROUND

The use of network-based data transaction systems has become commonplace across the world. For instance, users can perform a wide variety of transactions using a network-based finance application, such as using a portable device, e.g., a smartphone. While the availability of such applications can provide a great deal of convenience, transaction systems are not without challenges. For instance, automatic classification of such transactions can often be inaccurate and cause convoluted transaction histories leading to user dissatisfaction and a variety of computational inefficiencies.

### BRIEF DESCRIPTION OF THE DRAWINGS

Aspects of managing insights for data transactions are described with reference to the following Figures. The same numbers may be used throughout to reference similar features and components that are shown in the Figures:

FIG. 1 illustrates an example environment in which aspects of managing insights for data transactions can be implemented.

FIG. 2 depicts an example system for managing insights for data transactions in accordance with one or more implementations.

FIG. 3 depicts an example implementation for managing insights for data transactions in which a user interface is displayed that includes transaction insights that do not consider cashback transactions in accordance with one or more implementations.

FIG. 4 depicts an example implementation for managing insights for data transactions in which a user interface is displayed that includes transaction insights based on cashback transactions in accordance with one or more implementations.

FIG. 5 depicts an example implementation for managing insights for data transactions in which a user interface is displayed that includes a monitored status of a multi-condition transaction in accordance with one or more implementations.

FIG. 6 depicts an example implementation for managing insights for data transactions in which a user interface is displayed that includes an expanded region that includes details of a status of a multi-condition transaction in accordance with one or more implementations.

FIG. 7 depicts an example implementation for managing insights for data transactions in which alerts based on a monitored status of a multi-condition data transaction are displayed in accordance with one or more implementations.

FIG. 8 illustrates a flow chart depicting an example method for managing insights for data transactions in accordance with one or more implementations.

FIG. 9 illustrates a flow chart depicting an example method for monitoring multi-conditional data transactions in accordance with one or more implementations.

FIG. 10 illustrates various components of an example device in which aspects of managing insights for data transactions can be implemented in accordance with one or more implementations.

### DETAILED DESCRIPTION

Techniques for managing insights for data transactions are described and are implementable to generate accurate insights associated with a variety of data transactions, including data transactions that include multiple conditions such as “cashback” transactions. The techniques described herein further include implementations for monitoring such multi-condition data transactions and generation of alerts based on the monitoring.

Consider an example in which a user of a client device wishes to partake in a data transaction, such as to purchase services and/or goods from a service provider. In this example, the service provider offers a “cashback” incentive. The cashback incentive, for instance, indicates that the user will receive a portion of an amount spent back, such as in the form of digital currency and/or credit, after a set period of time. Cashback incentives are beneficial for both parties, such as to increase user savings and promote customer loyalty for the service provider. In this example, the user wishes to perform a data transaction to purchase a good, such as a television, for $1,000 with a 25% cashback. Thus, the user purchases the television and expects to receive $250 back in thirty days, which are the terms of the incentive in this example.

Accordingly, the data transaction includes a first condition that includes an initial data exchange between the client device and the service provider. For instance, the initial data exchange includes a resource transfer of a first amount from the client device to the service provider. In the context of the example, the initial data exchange represents payment from the user to the service provider for the television in the amount of $1000. The data transaction further includes a second condition that includes a pending data exchange between the client device and the service provider, such as a pending resource transfer of a second amount from the service provider to the client device. In the example, the pending data exchange represents a “cashback” for the user for the television, e.g., $250 that is completed subsequent to the initial data exchange, e.g., thirty days later.

Conventional transaction analysis approaches fail to generate accurate insights for such cashbacks due to a complex and dynamic nature of these transactions. For instance, these techniques misclassify transaction conditions such as in scenarios in which there is a temporal delay between multiple conditions of a data transaction. In the above example, for instance, the two conditions of the data transaction are incorrectly recorded by conventional approaches as independent transactions, e.g., a first transaction for $1000 is represented as an expense while a second transaction for $250 is represented as income thirty days later. Accordingly, such conventional techniques generate incomplete and/or inaccurate insights, which causes various computational inefficiencies as systems that implement these techniques repeatedly process and correct erroneous data. Further, manual adjustments required to correct these inaccuracies are time-consuming and resource-intensive, which further exacerbates inefficiencies and offsets advantages of transaction analysis techniques.

To overcome these limitations, the techniques described herein support accurate management of insights and alerts for multi-condition data transactions. The described implementations, for example, include a transaction management service that is implemented, e.g., by the client device, to detect transactions that include resource transfer reversal conditions (e.g., cashbacks) and generate one or more transaction insights related to the resource transfer reversal condition. The transaction management service is further implementable to monitor a status of the resource transfer reversal condition, such as while the resource transfer reversal condition is pending and generate alerts and/or notifications based on the monitored status.

For instance, consider a scenario such as the example described above, in which the user wishes to purchase a television with a 25% cashback. The client device initiates a data transaction between the client device and the service provider system, such as to initiate a purchase of the television. As described above, the data transaction includes a first condition that includes an initial data exchange from the client device to the service provider as well as a second condition that includes a pending data exchange between the client device and the service provider, such as a pending resource transfer from the service provider to the client device. While in this example the data transaction includes two conditions, this is by way of example and not limitation and data transactions with two or more conditions are considered.

The client device leverages the transaction management service to detect that the data transaction includes a pending resource transfer reversal condition. The pending resource transfer reversal condition, for instance, represents a cashback condition of the data transaction, e.g., the second condition. In at least one example, the transaction management service, e.g., as implemented by the client device, detects the pending resource transfer reversal condition via one or more queries to the client device, the service provider system and/or or a network transaction service, e.g., a digital banking service, associated with the client device and/or the service provider system. In various implementations, the transaction management service is implementable in part or in whole by one or more of the client device, the network transaction service, and/or the service provider system.

In an additional or alternative example, the transaction management service leverages one or more text extraction and/or text-recognition technologies (e.g., optical character recognition (“OCR”), natural language processing (“NLP”) machine learning models, etc.) to detect a digital message associated with the client device that indicates the pending resource transfer reversal condition. For example, the user receives a transaction confirmation via a digital communication from the service provider system that includes details about the cashback. The transaction management service detects the pending resource transfer reversal condition based on detection of one or more key words or phrases in the digital communication.

Responsive to detection of the pending resource transfer reversal condition, the transaction management service determines one or more metrics associated with the data transaction. The metrics, for instance, indicate a date and time of the data transaction, an amount of the transaction, and a mode of the transaction, e.g., a method of resource transfer. The metrics may also include information about the multiple components of the data transaction such as an amount, timeline, and/or mode for delivery of the pending resource transfer reversal condition and/or additional conditions of the data transaction.

The transaction management service can then generate a data transaction insight, such as to be displayed in a user interface of the client device, based on the pending resource transfer reversal condition and the one or more metrics. The data transaction insight, for instance, is an instance of digital content that includes analysis and/or observations derived from transaction data such as to represent spending patterns, behaviors, and/or trends related to the data transaction. For example, the data transaction insight includes one or more of a gross/net income and/or expense for a period of time, transaction categorization, transaction patterns, etc.

Continuing with the example, the transaction management service generates a data transaction insight based in part on the cashback that accurately reflects expenses of the user for a period of time. Whereas conventional techniques that do not account for multiple conditions of individual data transactions would inaccurately categorize the data transaction as a $1000 expense, the techniques described herein consider the pending resource transfer reversal condition and thus generate the insight to accurately reflect an actual expense of the user, e.g., $750.

In various examples, the transaction management service is further operable to monitor a status of the pending resource transfer reversal condition. For example, upon detection that the data transaction includes the pending resource transfer reversal condition, the transaction management service initiates a monitoring procedure to monitor a status of the pending resource transfer reversal condition. The status, for instance, is based on the one or more metrics associated with the data transaction such as an anticipated time/date, an amount, and a mode for the pending resource transfer reversal condition to occur. Based on the status, the transaction management service generates an alert such as for display in the user interface of the client device.

For example, the transaction management service determines that the resource transfer reversal condition has not yet been completed and generates an indication the resource transfer reversal condition is pending. In an example in which the resource transfer reversal condition is completed in accordance with the one or more metrics (e.g., the resource transfer reversal condition occurs on time, with a correct amount, and an anticipated mode of transfer) the transaction management service generates an indication that the resource transfer reversal condition has been completed successfully and terminates the monitoring procedure. In an additional or alternative example in which the resource transfer reversal condition is not completed in accordance with the one or more metrics, the transaction management service generates an alert to inform the user of the discrepancy. In this way, the techniques described herein overcome conventional limitations that fail to reconcile multiple conditions of a data transaction.

The techniques described herein support accurate management of data transactions, such as multi-condition data transactions. In various implementations, a payment transaction represents a data transaction. For instance, digital payment transactions involve generating, transmitting, and processing various types of data across a variety of different systems and networks. Thus, such digital payment transactions can be characterized as sets of computational operations much like other operations of a computing device and/or set of computing devices.

Accordingly, by supporting enhanced accuracy and increased information associated with the data transactions, the described techniques can conserve system resources (e.g., memory, processor bandwidth, network bandwidth, etc.) that may otherwise be needlessly expended to generate transaction insights based on inaccurate information and/or used to detect and/or correct transaction misattributions. Thus, the described techniques can improve the operation of computing devices and data networks. Further, user burden can be reduced by monitoring such data transactions automatically while reducing user interaction to initiate and manage data transaction information storage.

While features and concepts of managing insights for data transactions can be implemented in any number of environments and/or configurations, aspects of managing insights for data transactions are described in the context of the following example systems, devices, and methods.

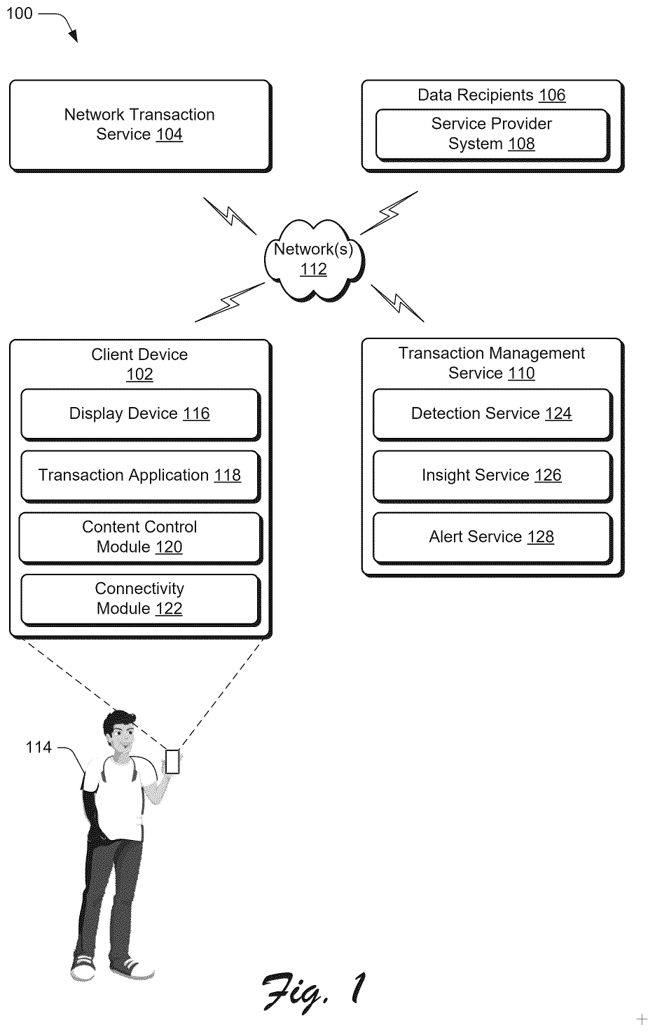

FIG. 1 illustrates an example environment 100 in which aspects of managing insights for data transactions can be implemented. The environment 100 includes a computing device such as a client device 102, a network transaction service 104, data recipients 106 such as a service provider system 108, and a transaction management service 110 that are interconnectable via a network 112. The network 112 represents a wireless and/or wired network to which the client device 102, the network transaction service 104, the data recipients 106 (e.g., the service provider system 108), and/or the transaction management service 110 can connect, such as to enable data communication as part of implementations for managing insights for data transactions as discussed herein.

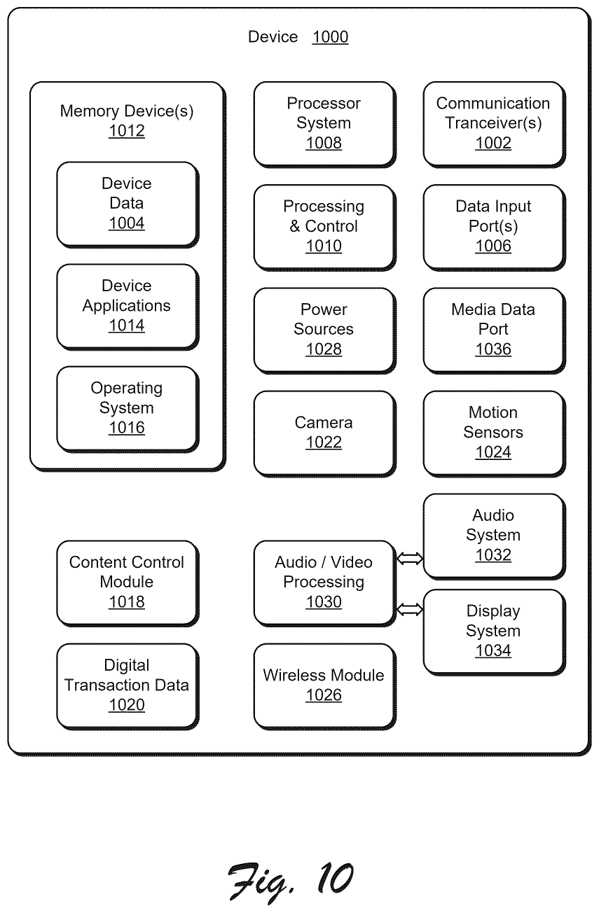

The client device 102 represents a computing device that can be used by a user 114 to perform, receive, and/or manage different data transactions, e.g., finance transactions such as purchasing goods and services. This is by way of example and not limitation, and a variety of data transactions are considered. In an example, the client device 102 represents a computing device that is operable, such as by a user 114, to communicate a request to complete a data transaction to a data recipient 106, such as a service provider system 108. The client device 102 can be implemented in various ways and include various functionality, examples of which are discussed below with reference to the example device 1000 of FIG. 10.

The client device 102 includes various functionality such as a display device 116, a transaction application 118, a content control module 120, and a connectivity module 122. The display device 116 represents functionality for graphic output by the client device 102, such as in a user interface of the client device 102. Further, the display device 116 can include touch input functionality, such as to enable the user to provide input to the client device 102 via touch input to the display device 116. As further described below, the transaction application 118 enables the client device 102 to access the network transaction service 104, such as to receive, initiate, and/or participate in various data transactions.

The content control module 120 represents functionality for performing various aspects of managing insights for data transactions described herein. In various examples, the content control module 120 is operable to leverage the transaction management service 110 to perform a variety of functionality. For instance, the content control module 120 is operable to cause the client device 102 to detect a multi-condition data transaction, generate one or more insights based on the multi-condition data transaction, and/or to monitor a status of the multi-condition data transaction as further described below.

The connectivity module 122 enables wireless and/or wired connectivity of the client device 102. For instance, the connectivity module 122 represents functionality (e.g., logic and hardware) for enabling the client device 102 to interconnect with other devices, storage systems, and/or networks, such as the network 112. In an example, the client device 102 leverages the connectivity module 122 to communicate with one or more of the network transaction service 104, the data recipients 106, and/or the transaction management service 110.

The network transaction service 104 represents a network-based service that is accessible to the client device 102 to perform a variety of data transactions. The network transaction service 104 can be implemented by various entities, such as a banking entity, a payment service, an enterprise entity, a trading entity, a data storage and/or management entity, and/or combinations thereof. The user 114, for instance, can utilize the transaction application 118 on the client device 102 to access the network transaction service 104 to perform different a variety of transactions, such as to transfer value amounts (e.g., monetary values) for different purposes, e.g., to purchase goods and services. The transaction application 118, for example, represents functionality that enables various finance-related transactions to be performed via the client device 102, including access to the network transaction service 104. In various examples, the network transaction service 104 is implementable as part of a connected ecosystem (e.g., a “super” application) along with the service provider system 108 and/or the transaction management service 110.

The data recipients 106 represent entities (e.g., computing devices) with which the client device 102 can engage in a data transaction. The client device 102, for instance, can initiate an exchange of data with the data recipients 106. For example, the data recipients 106 include a service provider system 108 that can provide goods and/or services to the user 114 and in exchange the client device 102 can cause a transfer of data (e.g., data representing an exchange of value) to the service provider system 108. In at least one implementation the data exchange between the client device 102 and the data recipients 106 is facilitated (e.g., managed) by the network transaction service 104. The network transaction service 104, for example, can implement a transfer of data (e.g., a data representation of value such as monetary value) to the data recipients 106 on behalf of the client device 102.

The transaction management service 110 represents a network-based service that can manage and/or monitor data transactions for various entities, such as the client device 102, the network transaction service 104, a data recipient 106 such as a service provider system 108, and so forth. For instance, when the client device 102 engages in a data transaction with a data recipient 106, the client device 102 can utilize the transaction management service 110 to detect a multi-condition data transaction, generate one or more insights based on the multi-condition data transaction, and/or to monitor a status of the multi-condition data transaction as further described below.

The transaction management service 110 includes various data and functionality for aspects of managing insights for data transactions. For instance, the transaction management service 110 includes a detection service 124, an insight service 126, and an alert service 128. As described in more detail in the following examples, the detection service 124 is configured to detect and identify various conditions of a data transaction, e.g., to detect a “cashback” condition. The insight service 126 can generate one or more insights about the data transaction, such as based on one or more of the conditions. The alert service 128 can generate a variety of alerts, such as for display by the display device 116, based on a status of one or more conditions of the data transaction.

Further, while the transaction management service 110 is illustrated as a separate entity than the client device 102, the network transaction service 104, and the data recipients 106, in at least one implementation the transaction management service 110 can be partially and/or wholly implemented and/or managed by one or more of the client device 102, the network transaction service 104, and/or the data recipients 106. The client device 102, the network transaction service 104, the transaction management service 110, and/or the data recipients 106 can be implemented in various ways and include various functionality, examples of which are discussed below with reference to the example device 1000 of FIG. 10.

Having discussed an example environment in which the disclosed techniques can be performed, consider now some example scenarios and implementation details for implementing the disclosed techniques.

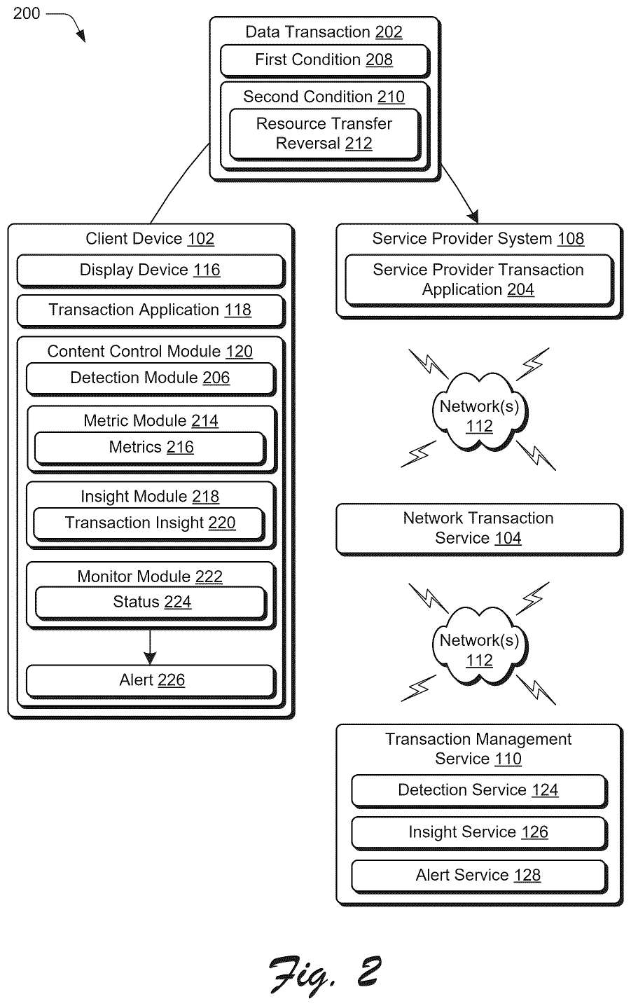

FIG. 2 depicts an example system 200 for managing insights for data transactions in accordance with one or more implementations. The system 200 can be implemented in the environment 100 and incorporates attributes of the environment 100 introduced above. In the example system 200, the client device 102 engages with the service provider system 108, such as to initiation a data transaction 202 between the client device 102 and the service provider system 108.

The data transaction 202 represents a transfer of resources between the client device 102 and the service provider system 108. In one example, the data transaction includes a transfer of financial resources, e.g., digital currency, cryptocurrencies, tokens, etc., such as in return for goods and/or services. This is by way of example and not limitation, and the data transaction 202 can include a transfer of a variety of resources and/or data, such as digital files, digital content, non-fungible tokens, messages, etc.

In various examples, the client device 102 utilizes a transaction application 118 to perform the data transaction 202. For instance, the client device 102 uses the transaction application 118 to access the network transaction service 104, such as to receive, initiate, and/or participate in the data transaction 202. In various examples, the service provider system 108 further includes a service provider transaction application 204 that is implementable to enable the service provider system 108 to participate in the data transaction 202, such as via communication with the network transaction service 104.

The client device 102 includes a content control module 120 that can leverage the transaction management service 110 to perform various aspects of managing insights for data transactions described herein. For instance, the content control module 120 includes a detection module 206 that can detect various conditions of the data transaction 202. In various examples, the detection module 206 leverages the detection service 124 of the transaction management service 110 to detect the various conditions. A condition, for instance, refers to one or more aspects, components, exchanges, and/or resource transfers that the data transaction 202 includes. Conventional transaction analysis approaches fail to generate accurate insights for multi-condition data transactions, and thus result in various computational inefficiencies.

To overcome these limitations, the detection module 206 detects that the data transaction 202 includes a first condition 208. The first condition 208, for instance, represents an initial data exchange between the client device 102 and the service provider system 108. For example, the initial data exchange includes a transfer of resources of a first data size (e.g., value, amount, etc.) from the client device 102 to the service provider system 108.

The detection module 206 further detects that the data transaction 202 includes a second condition 210. The second condition 210, for instance, represents a data exchange between the client device 102 and the service provider system 108 subsequent to the first condition 208. For example, the second condition 210 includes a resource transfer reversal 212, e.g., a pending resource transfer reversal condition, that represents a forthcoming resource transfer from the service provider system 108 to the client device 102. The resource transfer reversal 212, for instance, represents a “cashback” transaction in which a portion of the initial data exchange is returned to the client device 102.

The resource transfer reversal 212, for instance, is of a second data size that is less than the first data size. In one or more examples, the second data size is directly correlated to the first data size, such as a percentage of the first data size. While in this example the data transaction 202 includes a first condition 208 and a second condition 210, it should be understood that this is by way of example and not limitation and in various examples the data transaction 202 includes additional conditions, e.g., three or more conditions.

Based on detection of one or more of the first condition 208 and the second condition 210, the detection module 206 is further operable to classify the data transaction 202. For instance, based on detection of the resource transfer reversal 212, the detection module 206 classifies the data transaction 202 as a resource reversal transaction that involves at least a partial return of resources from the service provider system 108 to the client device 102. A variety of other data classifications are considered, such as classifiers to indicate the data transaction 202 includes a plurality of resource transfer reversals 212 (e.g., multiple cashbacks), classifiers based on computational resource usage, security information, data type, etc.

In one or more examples, the detection module 206 detects the first condition 208 and/or the second condition 210 based on metadata associated with the data transaction 202. For instance, the detection module 206 can access such metadata to identify the presence of the resource transfer reversal 212. Additionally or alternatively, the detection module 206 detects the conditions of the data transaction 202 via one or more queries to one or more of the service provider system 108, the transaction management service 110, and/or the network transaction service 104. In at least one implementation, one or more of the transaction management service 110, the service provider system 108, and/or the network transaction service 104 are connected via an application ecosystem, and the detection module 206 detects the first condition 208 and/or the second condition 210 via one or more queries to the application ecosystem.

In at least one example, the detection module 206 leverages one or more text-recognition technologies (e.g., OCR, NLP machine learning models, etc.) to detect/identify the conditions of the data transaction 202. For instance, the client device 102 initiates the data transaction 202 via the transaction application 118, and receives a transaction receipt, such as via a digital message (e.g., text message, notification such as a push notification, email, etc.). Alternatively or additionally, the client device 102 initiates the data transaction 202 via a digital message. The detection module 206 implements the one or more text-recognition technologies to identify key words, strings, and/or phrases within one or more of the digital messages that indicate that the data transaction 202 is a resource reversal transaction. For instance, the detection module 206 detects that a message includes the word “cashback” and accordingly, determines that the associated data transaction 202 includes a resource transfer reversal 212.

The content control module 120 further includes a metric module 214 that can determine one or more metrics 216 associated with the data transaction 202. In various examples, the metric module 214 determines the one or more metrics 216 responsive to detection of the resource transfer reversal 212 included in the data transaction 202. The one or more metrics 216, for instance, indicate a date and time of the data transaction 202, an amount (e.g., size, value, etc.) of the data transaction 202, a data transaction resource consumption indication, and/or a mode/type of the data transaction 202, e.g., a method of resource transfer.

The one or more metrics 216 may further pertain to the first condition 208 and/or the second condition 210. For instance, the one or more metrics 216 indicate an amount, a delivery timeline, a delivery mode, etc. for the first condition 208 and/or the second condition 210. For example, the one or more metrics 216 indicate an anticipated timeline for completion of the resource transfer reversal 212 of the second condition 210, as well as an expected delivery mode and amount.

In some implementations, the one or more metrics 216 further pertain to a relationship between the first condition 208 and the second condition 210, e.g., a ratio of an amount associated with the first condition 208 to an amount associated with the second condition 210. The metric module 214 can determine the one or more metrics 216 in a variety of ways, such as based on metadata associated with the data transaction 202, one or more queries to the application ecosystem, using text-recognition strategies, etc. as described above with respect to the detection module 206.

The content control module 120 further includes an insight module 218 that is operable to generate a transaction insight 220, such as to be displayed in a user interface of the display device 116. The transaction insight 220, for instance, is based on one or more of the first condition 208, the second condition 210, the resource transfer reversal 212 and/or the one or more metrics 216. In various embodiments, the insight module 218 leverages functionality of the insight service 126 of the transaction management service 110 to generate the transaction insight 220.

In an example, the transaction insight 220 includes an instance of digital content that includes analysis and/or observations to represent transaction patterns, behaviors, and/or trends related to the data transaction 202. For example, transaction insight 220 includes one or more of a gross/net income and/or expense for a period of time, transaction categorization, transaction patterns, etc. In various embodiments, the transaction insight 220 represents a relationship between a plurality of data transactions and/or a plurality of pending resource transfer reversal conditions. In additional or alternative examples, the transaction insight 220 includes a visual representation of a relationship between the first condition 208 and the second condition 210, such as a ratio of the first data size to the second data size.

The transaction insight 220 can further include a variety of information and/or representations such as a data transaction history, a data transaction resource usage summary, categorization of data transactions, data transaction recommendations (e.g., to reduce cost and/or computational expense), data transaction anomalies, etc. This is by way of example and not limitation, and a variety of transaction insights 220, e.g., transaction insights 220 related to multi-condition data transactions, are considered. In various examples, the insight module 218 is further operable to generate an indication for display in the user interface that the resource transfer reversal 212 of the data transaction 202 is pending.

The content control module 120 further includes a monitor module 222 that can monitor a status 224 of the resource transfer reversal 212. In various examples, the monitor module 222 leverages the alert service 128 of the transaction management service 110 to determine the status 224. The monitor module 222 can leverage a variety of techniques to monitor the status 224, such as monitoring metadata associated with the data transaction 202, one or more queries to the application ecosystem, using text-recognition strategies, etc.

In some embodiments, the monitor module 222 initiates a monitoring procedure to monitor the status 224 responsive to receipt of user consent to monitor the status 224. For instance, the monitor module 222 causes an indication to be output, such as by the display device 116, that includes details of the resource transfer reversal 212 as well as a request to begin the monitoring procedure. Responsive to an affirmative reply by the user 114, the monitor module 222 begins to monitor the status 224. Additionally or alternatively, the monitor module 222 monitors the status 224 automatically and without user intervention.

In one or more examples, the monitor module 222 can determine whether the resource transfer reversal 212 has been completed and/or whether the resource transfer reversal 212 has been completed in the correct amount/mode. Thus, the status 224 can indicate the resource transfer reversal 212 is pending, has been credited, and/or has been credited incorrectly. Based on the status 224, the monitor module 222 can generate an alert 226 such as for display in a user interface of the display device 116.

In one example, for instance, the monitor module 222 obtains the one or more metrics 216 such as described above. In this example, the one or more metrics 216 indicate an amount of the anticipated resource transfer reversal 212, a target date that the resource transfer reversal 212 is to occur, and a mode of delivery of the resource transfer reversal 212. The monitor module 222 determines the status 224 of the resource transfer reversal 212, which in this example indicates that the resource transfer reversal 212 is pending however the target date is forthcoming. Accordingly, the monitor module 222 generates the alert 226 to indicate that the resource transfer reversal 212 is pending.

In an additional or alternative example, the monitor module 222 determines the status 224 to indicate that the resource transfer reversal 212 has been completed. The monitor module 222 further confirms one or more criteria, e.g., that the amount of the resource transfer reversal 212 matches an anticipated amount, the completion date of the resource transfer reversal 212 matches the target date, and/or the mode of transaction is as expected. Upon confirmation that such criteria have been satisfied, the monitor module 222 generates the alert 226 to indicate successful completion of the resource transfer reversal 212 and terminates, e.g., ceases, the monitoring procedure.

However, in an example in which one or more of the criteria are not satisfied, e.g., the amount of the resource transfer reversal 212 is less than anticipated, the monitor module 222 generates the alert 226 to indicate the discrepancy. In various examples, the alert 226 further includes selectable indicia to contact the service provider system 108 to resolve the issue. In various embodiments, responsive to generation of the alert 226, the monitor module 222 causes the alert 226 to be communicated to the service provider system 108 to resolve the discrepancy automatically and without user intervention. In this way, the techniques described herein overcome the limitations of conventional techniques that are unable to generate insights for and/or monitor multi-condition data transactions and thus face increased computational overhead as a result of inaccurate transaction insights.

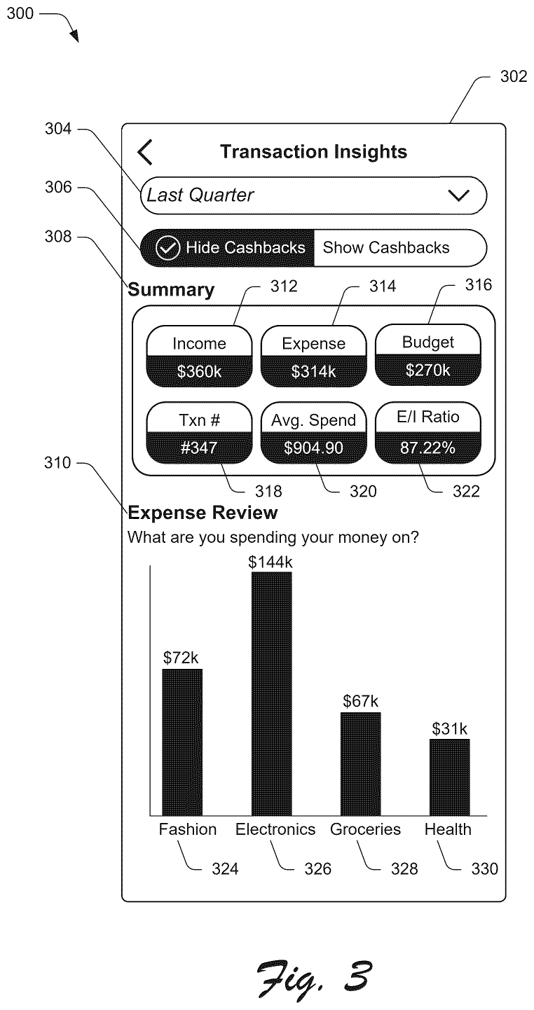

FIG. 3 depicts an example implementation 300 for managing insights for data transactions in which a user interface is displayed that includes transaction insights that do not consider cashback transactions in accordance with one or more implementations. As shown in the illustrated example, a graphical user interface 302 may be generated, presented, and/or managed by the client device 102 that depicts insights for a data transaction such as a payment transaction. The graphical user interface 302 includes a time period selection 304, a selectable indicia 306, a summary region 308, and an expense review region 310.

The time period selection 304 indicates a period of time for which the transaction insights 220 are generated. In the illustrated example, the period of time is “last quarter.” Thus, the transaction insights 220 included in the graphical user interface 302 pertains to data transactions 202 that occurred in the last quarter. The selectable indicia 306 includes a toggle button that is selectable, such as by a user 114, to either include resource transfer reversal 212 conditions (e.g., “cashbacks”) in the transaction insights 220 or to generate insights without consideration for the resource transfer reversal 212 conditions. In this example, the toggle button is selected such that cashbacks are not considered.

The summary region 308 includes a variety of transaction insights 220 that do not provide additional consideration for cashback transactions. The summary region 308 includes an income indication 312, an expense indication 314, a budget indication 316, a number of transactions indication 318, an average spend indication 320, and an expense to income ratio 322. The expense review region 310 includes a graph that categorizes expenses, such as a fashion category 324, an electronics category 326, a groceries category 328, and a health category 330.

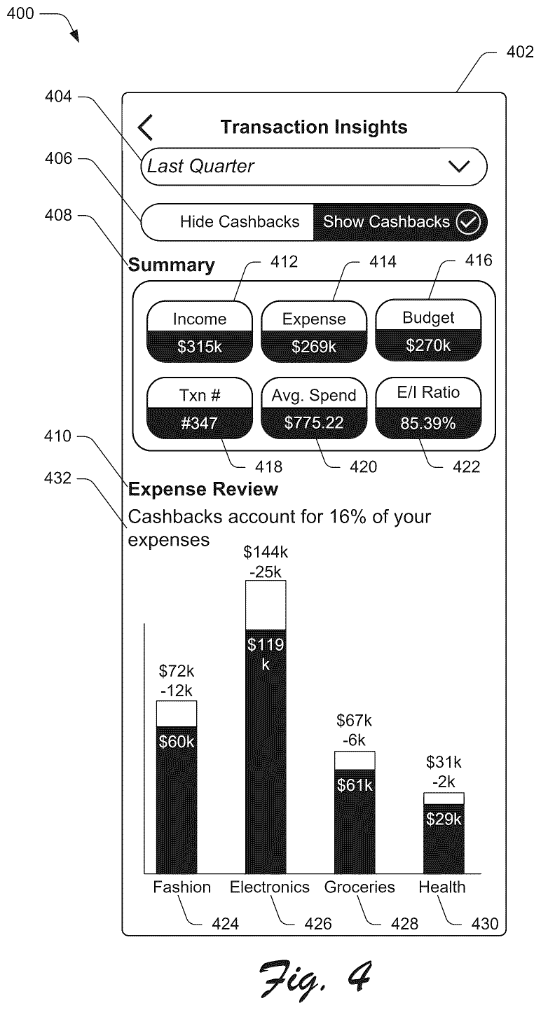

FIG. 4 depicts an example implementation 400 for managing insights for data transactions in which a user interface is displayed that includes transaction insights based on cashback transactions in accordance with one or more implementations. As shown in the illustrated example, a graphical user interface 402 may be generated, presented, and/or managed by the client device 102 that depicts transaction insights for a data transaction such as a payment transaction. The graphical user interface 402, for instance, represents the graphical user interface 302 with the toggle button selected to include cashbacks.

For instance, the graphical user interface 402 includes a time period selection 404, a selectable indicia 406, a summary region 408, and an expense review region 410. As in FIG. 3, the time period selection 404 indicates a period of time for which the transaction insights 220 are generated, e.g., last quarter. In this example, the selectable indicia 406 includes a toggle button that is selected such that cashbacks, e.g., resource transfer reversal 212 conditions, are considered in the generation and display of transaction insights 220.

The summary region 408 includes a variety of transaction insights 220 generated in accordance with the techniques described herein that consider cashback conditions of a variety of data transactions. Similar to the above example, the summary region 408 includes an income indication 412, an expense indication 414, a budget indication 416, a number of transactions indication 418, an average spend indication 420, and an expense to income ratio 422. The number of transactions indication 418 as well as the budget indication 416 remain unchanged relative to FIG. 3. However, the income indication 412, the expense indication 414, the average spend indication 420, and the income ratio 422 vary relative to the corresponding indications in FIG. 3 based on consideration of the cashback conditions of data transactions.

For instance, the income indication 312 and the expense indication 314 in FIG. 3 are inaccurately inflated. Accordingly, insights generated without consideration for cashbacks show that the user 114 of the client device 102 is “over budget” which is not the case as illustrated in FIG. 4. By considering cashbacks when generating transaction insights 220, the techniques described herein provide an accurate representation of a variety of metrics associated with multi-condition data transactions.

The expense review region 410 further includes a graph that categorizes expenses, such as a fashion category 424, an electronics category 426, a groceries category 428, and a health category 430. The expense review region 410 further includes an insight 432 that indicates that cashback transactions account for 16% of expenses. The expense review region 410 further provides a visualization of an impact of cashback conditions on each category 424-430, e.g., how much a user 114 has “saved” by engaging in cashback transactions.

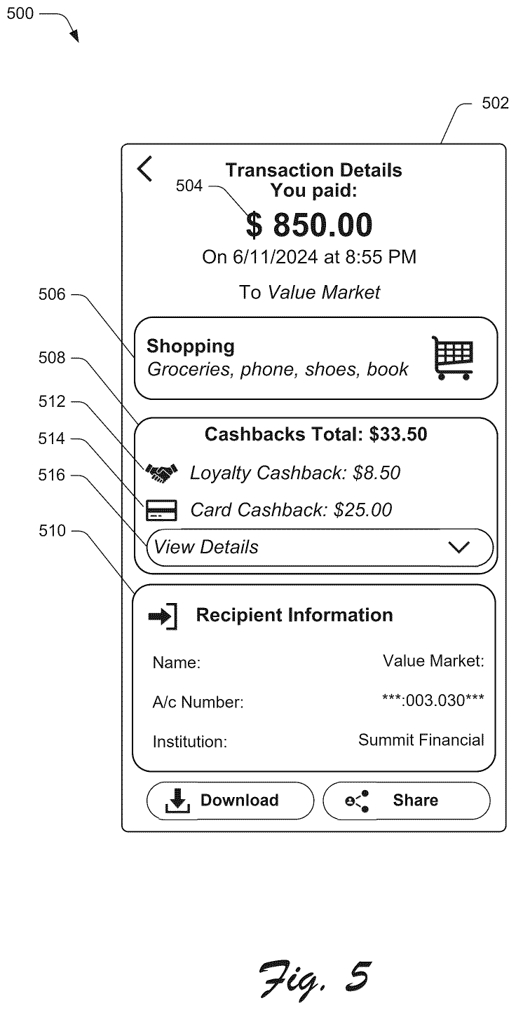

FIG. 5 depicts an example implementation 500 for managing insights for data transactions in which a user interface is displayed that includes a monitored status of a multi-condition transaction in accordance with one or more implementations. As shown in the illustrated example, a graphical user interface 502 is presented by a client device 102 that includes various information about a data transaction 202, such as a multi-conditional transaction with multiple cashback aspects. The graphical user interface 502 includes a transaction overview region 504, a categorization region 506, a cashback summary region 508, and a recipient information region 510.

The transaction overview region 504 indicates a payment amount of the data transaction 202 (e.g., $850.00) as well as a date of the data transaction 202, a time of the data transaction 202, and a recipient of the data transaction 202. The categorization region 506 indicates a category for the data transaction 202 as determined in accordance with the techniques described herein. In the illustrated example, the categorization region 506 indicates that the data transaction 202 is categorized as “shopping”. The recipient information region 510 includes information about a recipient of the data transaction 202, e.g., a service provider system 108 (“Value Market”) which the client device 102 engages with to perform the data transaction 202.

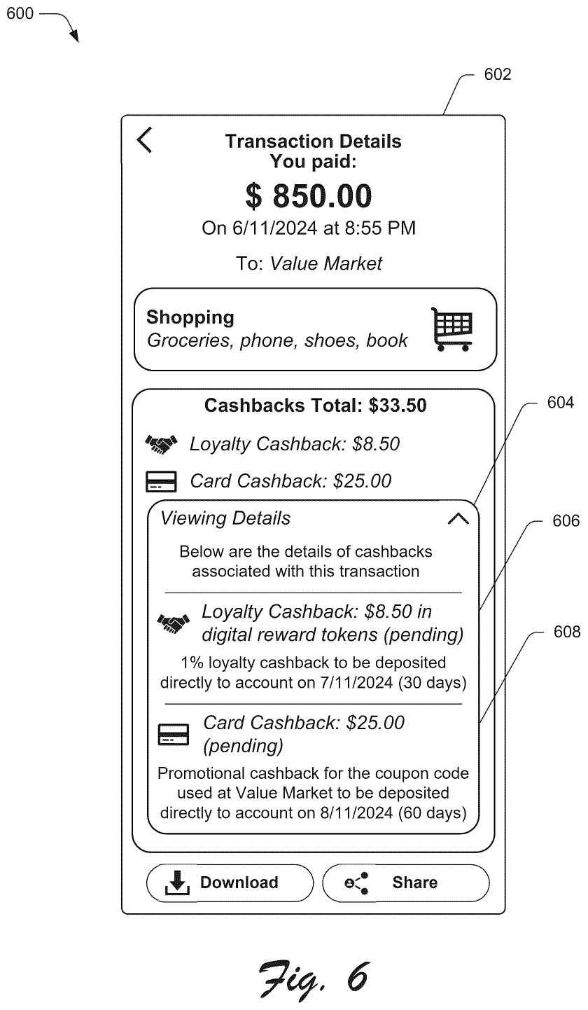

The cashback summary region 508 indicates that the data transaction 202 includes two resource transfer reversals 212, e.g., two cashback conditions. For instance, the client device 102 detects a first cashback 512 and a second cashback 514 in accordance with the techniques described herein. The first cashback 512 includes a “loyalty cashback” in the amount of $8.50 while the second cashback 514 includes a “card cashback” in the amount of $25.00. The cashback summary region 508 further includes an expandable region 516 that is actuatable to display additional details associated with the first cashback 512 and the second cashback 514, such as depicted in FIG. 6.

FIG. 6 depicts an example implementation 600 for managing insights for data transactions in which a user interface is displayed that includes an expanded region that includes details of a status of a multi-condition transaction in accordance with one or more implementations. As shown in the illustrated example, a graphical user interface 602 is presented by a client device 102. The graphical user interface 602, for instance, represents a continuation of the example discussed above with respect to FIG. 5 in which the expandable region 516 is selected.

Accordingly, the graphical user interface 602 includes an expanded region 604 that includes additional details about the first cashback 512 and the second cashback 514. For instance, the client device 102 is operable to monitor the first cashback 512 and the second cashback 514 to determine a status 224 of each condition in accordance with the techniques described herein. Based on the respective statuses 224, the client device 102 can generate a variety of digital content for display.

For example, the expanded region 604 includes a first detailed region 606 that corresponds to the first cashback 512 and a second detailed region 608 that corresponds to the second cashback 514. The first detailed region 606, for instance, indicates an amount of the first cashback 512 (e.g., 1% of the amount of the data transaction 202), a mode of the first cashback 512 (e.g., digital reward tokens to be deposited directly) and a description of the first cashback 512. The first detailed region 606 further includes an anticipated date that the first cashback 512 is to be completed, e.g., thirty days from the date of the data transaction 202. Accordingly, the first detailed region 606 includes an indication that the first cashback 512 is pending.

Similarly, the second detailed region 608 indicates an amount of the first cashback 512 (e.g., $25.00), a mode of the first cashback 512 (e.g., cashback to be deposited directly) and a description of the first cashback 512, such as for a coupon code used with the service provider system 108. The second detailed region 608 further includes an anticipated date that the second cashback 514 is to be completed, e.g., sixty days from the date of the data transaction 202 and an indication that the second cashback 514 is pending. Thus, by monitoring multi-condition data transactions the techniques described herein support generation of a variety of alerts and visual digital content to enhance a user experience.

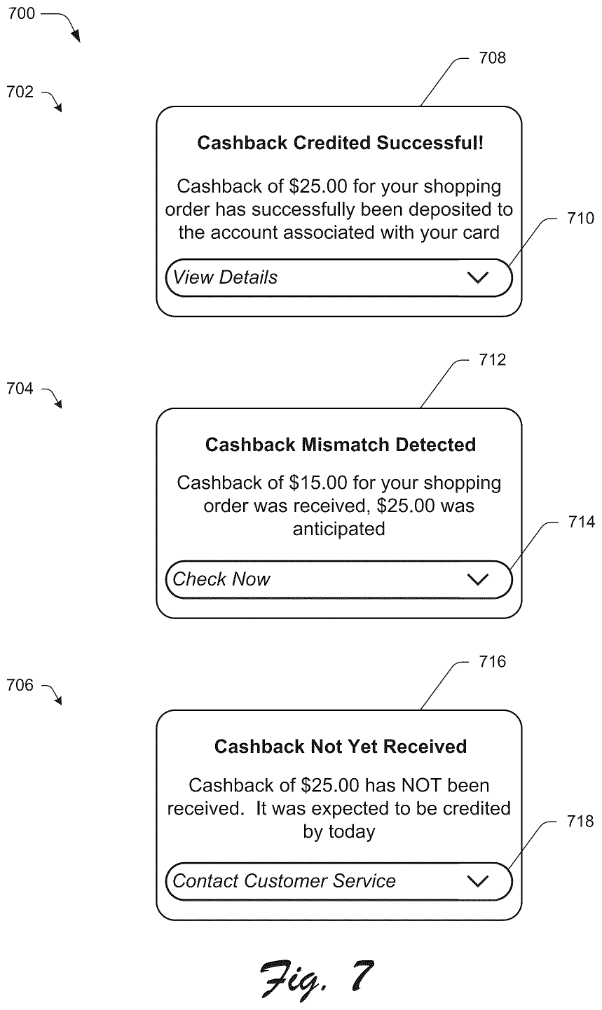

FIG. 7 depicts an example implementation 700 for managing insights for data transactions in which alerts based on a monitored status of a multi-condition data transaction are displayed in accordance with one or more implementations. In this example, shown in a first example 702, a second example 704, and a third example 706, a client device 102 monitors a status 224 of one or more resource transfer reversals 212 (e.g., a cashback) as part of one or more data transactions 202 with a service provider system 108 in accordance with the techniques described herein. Based on the determined status, the client device 102 generates an alert 226 for display, such as in a user interface of the client device 102.

In the first example 702, the client device 102 determines that a resource transfer reversal 212 has been credited successfully. For instance, the client device 102 determines that a time, amount, and mode of the resource transfer reversal 212 are correct. Accordingly, the client device 102 generates an alert 708 that indicates that the cashback has been credited successfully. The alert 708 further includes details of the resource transfer reversal 212, as well as an expandable region 710 to view additional details of the resource transfer reversal 212.

In the second example 704, the client device 102 determines that a resource transfer reversal 212 has been received, however an amount of the resource transfer reversal 212 is incorrect. Accordingly, the client device 102 generates an alert 712 that indicates the mismatch. The alert 712 further includes an expandable region 714 that includes a link to view additional details of the resource transfer reversal 212 and contact the service provider system 108 to correct the mistake.

In the third example 706, the client device 102 determines that a resource transfer reversal 212 has not been received, despite being past an anticipated date for the resource transfer reversal 212 to occur. Accordingly, the client device 102 generates an alert 716 that indicates that the cashback is late. The alert 716 further includes an expandable region 718 that includes a link to contact the service provider system 108 to correct the mistake. Such monitoring and altering is not possible using conventional techniques that fail to account for various conditions of multi-conditional data transactions.

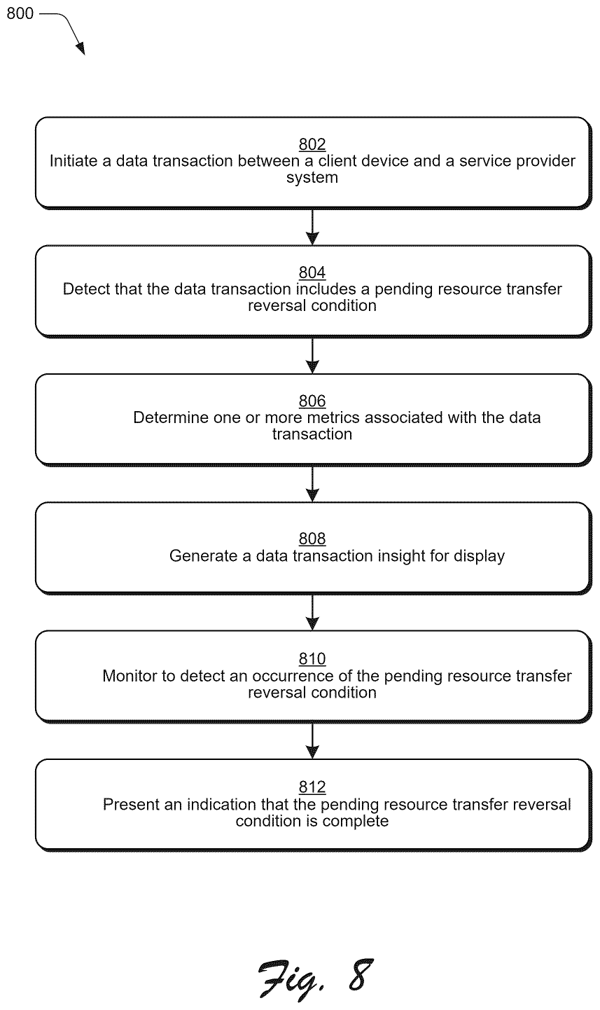

FIG. 8 illustrates a flow chart depicting an example method 800 for managing insights for data transactions in accordance with one or more implementations. At 802, a data transaction between a client device and a service provider system is initiated. The data transaction 202 represents a transfer of resources between the client device 102 and the service provider system 108. In one example, the data transaction includes a transfer of financial resources, e.g., digital currency, cryptocurrencies, tokens, etc., such as in return for goods and/or services. This is by way of example and not limitation, and the data transaction 202 can include a transfer of a variety of resources and/or data, such as digital files, digital content, non-fungible tokens, messages, etc. In at least one example, the client device 102 initiates the data transaction 202 using a transaction application 118. Alternatively or additionally, the transaction management service 110 receives a request to initiate the data transaction 202.

At 804, it is detected that the data transaction includes a pending resource transfer reversal condition. For instance, the client device 102 and/or the transaction management service 110 detect that the data transaction 202 includes a first condition 208 and a second condition 210. A condition, for instance, refers to one or more aspects, components, exchanges, and/or resource transfers included in the data transaction 202.

The first condition 208, for instance, represents an initial data exchange between the client device 102 and the service provider system 108. The second condition 210, for instance, represents a data exchange between the client device 102 and the service provider system 108 subsequent to the first condition 208. For example, the second condition 210 includes a resource transfer reversal 212, e.g., a pending resource transfer reversal condition, that represents a forthcoming resource transfer from the service provider system 108 to the client device 102. In at least one example, the client device 102 and/or the transaction management service 110 generate a classification for the data transaction 202 based on the first condition 208, the second condition 210, and/or the resource transfer reversal 212.

At 806, one or more metrics associated with the data transaction are determined. For instance, the client device 102 and/or the transaction management service 110 determine the one or more metrics 216 responsive to detection of the resource transfer reversal 212. The one or more metrics 216, for instance, indicate a date and time, an amount (e.g., size, value, etc.), a data transaction resource consumption indication, and/or a mode/type of the data transaction 202, the first condition 208, the second condition 210, and/or the resource transfer reversal 212.

At 808, a data transaction insight is generated for display. The transaction insight 220, for instance, is generated (such as by the client device 102 and/or the transaction management service 110) based on one or more of the one or more metrics 216, the first condition 208, the second condition 210, and/or the resource transfer reversal 212. In an example, the transaction insight 220 includes an instance of digital content that includes analysis and/or observations to represent transaction patterns, behaviors, and/or trends related to the data transaction 202. The transaction insight 220 can then be presented, such as by a display device 116 of the client device 102.

At 810, an occurrence of the pending resource transfer reversal condition is monitored. For instance, the client device 102 and/or the transaction management service 110 monitors the second condition 210 to determine whether the resource transfer reversal 212 has occurred, e.g., been credited from the service provider system 108 to the client device 102. While the resource transfer reversal 212 is pending, the client device 102 and/or the transaction management service 110 can generate an indication to indicate that the resource transfer reversal 212 is pending.

At 812, an indication that the pending resource transfer reversal condition is complete is presented. For instance, the client device 102 and/or the transaction management service 110 detect that the resource transfer reversal 212 has occurred and generates an indication to indicate that the resource transfer reversal 212 is complete.

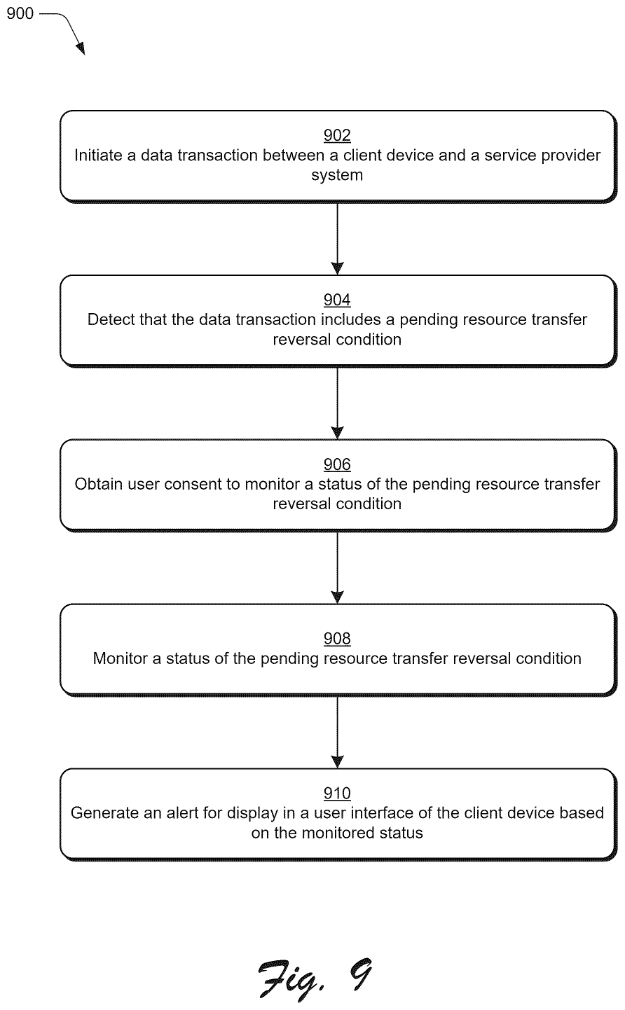

FIG. 9 illustrates a flow chart depicting an example method 900 for monitoring multi-conditional data transactions in accordance with one or more implementations. At 902, a data transaction between a client device and a service provider system is initiated. The data transaction 202 represents a transfer of resources between the client device 102 and the service provider system 108. In at least one example, the client device 102 initiates the data transaction 202 using a transaction application 118. Alternatively or additionally, the transaction management service 110 receives a request to initiate the data transaction 202, such as from the client device 102 and/or the service provider system 108.

At 904, it is detected that the data transaction includes a pending resource transfer reversal condition. For instance, the client device 102 and/or the transaction management service 110 detect that the data transaction 202 includes a first condition 208 and a second condition 210. The first condition 208, for instance, represents an initial data exchange between the client device 102 and the service provider system 108. The second condition 210, for instance, represents a data exchange between the client device 102 and the service provider system 108 subsequent to the first condition 208. For example, the second condition 210 includes a resource transfer reversal 212, e.g., a pending resource transfer reversal condition, that represents a forthcoming resource transfer from the service provider system 108 to the client device 102.

In one or more examples, the client device 102 and/or the transaction management service 110 detects the first condition 208 and/or the second condition 210 based on metadata associated with the data transaction 202. Additionally or alternatively, the conditions of the data transaction 202 are detected via one or more queries to one or more of the service provider system 108, the transaction management service 110, and/or the network transaction service 104. In at least one example, the client device 102 and/or the transaction management service 110 leverage one or more text-recognition technologies (e.g., OCR, NLP machine learning models, etc.) to detect/identify the conditions of the data transaction 202.

At 906, user consent to monitor a status of the pending resource transfer reversal condition is obtained. For instance, the client device 102 and/or the transaction management service 110 causes an indication to be output, such as by the display device 116, that includes details of the resource transfer reversal 212 as well as a request to begin a monitoring procedure. Responsive to an affirmative reply by the user 114, the monitor module 222 begins to monitor the status 224. Additionally or alternatively, the client device 102 and/or the transaction management service 110 initiates the monitoring procedure automatically and without user intervention.

At 908, a status of the pending resource transfer reversal condition is monitored. In one or more examples, the client device 102 and/or the transaction management service 110 monitor the status 224 based on one or more criteria for the resource transfer reversal 212 to fulfil. The one or more criteria indicate anticipated properties of the resource transfer reversal 212, such as an expected transaction amount, a transaction target date, and a transaction mode. In at least one example, the one or more criteria are determined based on the one or more metrics 216 as described in more detail above.

At 910, an alert is generated such as for display in a user interface of the client device. For instance, the client device 102 and/or the transaction management service 110 generate the alert 226 based on the monitored status 224. In an example, the alert 226 indicates whether or not the resource transfer reversal 212 has satisfied the one or more criteria.

In one or more examples, the status 224 indicates that the resource transfer reversal 212 has occurred in accordance with the one or more criteria and the alert 226 indicates that the resource transfer reversal 212 has been successfully completed. In an additional or alternative example, the status 224 indicates that one or more of the criteria have not been satisfied and the alert 226 indicates which of the criteria have not been satisfied. In this way, the techniques described herein overcome the limitations of conventional techniques that do not provide consideration for multi-condition data transactions and thus face increased computational overhead as systems that implement these techniques repeatedly process and correct erroneous data.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 10 illustrates various components of an example device 1000 in which aspects of managing insights for data transactions can be implemented. The example device 1000 can be implemented as any of the devices described with reference to the previous FIGS. 1-9, such as any type of mobile device, mobile phone, mobile device, wearable device, tablet, computing, communication, entertainment, gaming, media playback, and/or other type of electronic device. For example, the client device 102 as shown and described with reference to FIGS. 1-9 may be implemented as the example device 1000.

The device 1000 includes communication transceivers 1002 that enable wired and/or wireless communication of device data 1004 with other devices. The device data 1004 can include any of device identifying data, device location data, wireless connectivity data, and wireless protocol data. Additionally, the device data 1004 can include any type of audio, video, and/or image data. Example communication transceivers 1002 include wireless personal area network (WPAN) radios compliant with various IEEE 1002.15 (Bluetooth™) standards, wireless local area network (WLAN) radios compliant with any of the various IEEE 1002.11 (Wi-Fi™) standards, wireless wide area network (WWAN) radios for cellular phone communication, wireless metropolitan area network (WMAN) radios compliant with various IEEE 1002.16 (WiMAX™) standards, and wired local area network (LAN) Ethernet transceivers for network data communication.

The device 1000 may also include one or more data input ports 1006 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1000 includes a processing system 1008 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1010. The device 1000 may further include any type of a system bus or other data and command transfer system that couples the various components within the device. A system bus can include any one or combination of different bus structures and architectures, as well as control and data lines.

The device 1000 also includes computer-readable storage memory 1012 (e.g., memory devices) that enable data storage, such as data storage devices that can be accessed by a computing device, and that provide persistent storage of data and executable instructions (e.g., software applications, programs, functions, and the like). Examples of the computer-readable storage memory 1012 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1000 may also include a mass storage media device.

The computer-readable storage memory 1012 provides data storage mechanisms to store the device data 1004, other types of information and/or data, and various device applications 1014 (e.g., software applications). For example, an operating system 1016 can be maintained as software instructions with a memory device and executed by the processing system 1008. The device applications may also include a device manager, such as any form of a control application, software application, signal-processing and control module, code that is native to a particular device, a hardware abstraction layer for a particular device, and so on. Computer-readable storage memory 1012 represents media and/or devices that enable persistent and/or non-transitory storage of information in contrast to mere signal transmission, carrier waves, or signals per se. Computer-readable storage memory 1012 do not include signals per se or transitory signals.

In this example, the device 1000 includes a content control module 1018 that implements aspects of managing insights for data transactions and may be implemented with hardware components and/or in software as one of the device applications 1014. In an example, the content control module 1018 can be implemented as the content control module 120 described in detail above. In implementations, the content control module 1018 may include independent processing, memory, and logic components as a computing and/or electronic device integrated with the device 1000. The device 1000 also includes digital transaction data 1020 for implementing aspects of managing insights for data transactions and may include data from and/or utilized by the content control module 1018.

In this example, the example device 1000 also includes a camera 1022 and motion sensors 1024, such as may be implemented in an inertial measurement unit (IMU). The motion sensors 1024 can be implemented with various sensors, such as a gyroscope, an accelerometer, and/or other types of motion sensors to sense motion of the device. The various motion sensors 1024 may also be implemented as components of an inertial measurement unit in the device.

The device 1000 also includes a wireless module 1026, which is representative of functionality to perform various wireless communication tasks. For instance, for the client device 102, the wireless module 1026 can be leveraged to scan for and detect wireless networks, as well as negotiate wireless connectivity to wireless networks for the client device 102. The device 1000 can also include one or more power sources 1028, such as when the device is implemented as a mobile device. The power sources 1028 may include a charging and/or power system, and can be implemented as a flexible strip battery, a rechargeable battery, a charged super-capacitor, and/or any other type of active or passive power source.

The device 1000 also includes an audio and/or video processing system 1030 that generates audio data for an audio system 1032 and/or generates display data for a display system 1034. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1036. In implementations, the audio system and/or the display system are integrated components of the example device. Alternatively, the audio system and/or the display system are external, peripheral components to the example device.

Although implementations of managing insights for data transactions have been described in language specific to features and/or methods, the subject of the appended claims is not necessarily limited to the specific features or methods described. Rather, the features and methods are disclosed as example implementations of managing insights for data transactions, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device, including: at least one memory; and at least one processor coupled with the at least one memory and configured to cause the client device to: detect that a data transaction between the client device and a service provider system includes a pending resource transfer reversal condition; monitor a status of the pending resource transfer reversal condition; and generate an alert for display in a user interface of the client device based on the monitored status.

In some aspects, the techniques described herein relate to a client device, wherein the data transaction includes an initial data exchange of a first data amount from the client device to the service provider system and the pending resource transfer reversal condition includes a subsequent data exchange of a second data amount from the service provider system to the client device, the second data amount less than the first data amount.

In some aspects, the techniques described herein relate to a client device, wherein the status indicates that the resource transfer reversal condition has not occurred and the alert indicates that the resource transfer reversal condition is pending.

In some aspects, the techniques described herein relate to a client device, wherein the status indicates that the resource transfer reversal condition has occurred and the alert indicates that the resource transfer reversal condition has been successfully completed.

In some aspects, the techniques described herein relate to a client device, wherein to monitor the status includes determining one or more criteria for the pending resource transfer reversal condition to fulfil, and wherein the alert indicates whether the pending resource transfer reversal condition has satisfied the one or more criteria.

In some aspects, the techniques described herein relate to a client device, wherein the one or more criteria include a transaction amount, a transaction target date, and a transaction mode.

In some aspects, the techniques described herein relate to a client device, wherein the status indicates that one or more of the criteria have not been satisfied and the alert indicates which of the criteria have not been satisfied.

In some aspects, the techniques described herein relate to a client device, wherein the client device is further configured to cease monitoring the status responsive to detection of successful completion of the resource transfer reversal condition.

In some aspects, the techniques described herein relate to a client device, wherein the client device is further configured to generate a query for display in the user interface to obtain consent to monitor the status, and to monitor the status responsive to receipt of an affirmative response to the query.

In some aspects, the techniques described herein relate to a method performed by a client device, the method including: initiating, by the client device, a data transaction between the client device and a service provider system; detecting that the data transaction includes: a first condition that includes an initial resource transfer from the client device to the service provider system; and a second condition that includes a pending resource transfer from the service provider system to the client device; monitor a status of the second condition of the data transaction; and generate an alert for display in a user interface of the client device based on the monitored status.

In some aspects, the techniques described herein relate to a method, wherein the status indicates that the pending resource transfer of the second condition has not occurred and the alert indicates that the second condition is pending.

In some aspects, the techniques described herein relate to a method, wherein the status indicates that the pending resource transfer of the second condition has occurred and the alert indicates that the pending resource transfer has been successfully completed.

In some aspects, the techniques described herein relate to a method, further including determining one or more criteria for the second condition to fulfill and wherein the alert indicates whether the pending resource transfer has satisfied the one or more criteria.

In some aspects, the techniques described herein relate to a method, wherein the one or more criteria include a transaction amount, a transaction target date, and a transaction mode.

In some aspects, the techniques described herein relate to a method, wherein the status indicates that one or more of the criteria have not been satisfied and the alert indicates which of the criteria have not been satisfied.

In some aspects, the techniques described herein relate to a method, further including ceasing monitoring the status responsive to detection of successful completion of the pending resource transfer.

In some aspects, the techniques described herein relate to a system, including: at least one memory; and at least one processor coupled to the at least one memory and configured to cause the system to: receive a request to initiate a data transaction between a first client device and a second client device; detect that the data transaction includes: a first condition that includes an initial resource transfer from the first client device to the second client device; and a second condition that includes a pending resource transfer from the second client device to the first client device; monitor a status of the second condition; and generate an alert for display in a user interface of the first client device based on the monitored status.

In some aspects, the techniques described herein relate to a system, wherein the status indicates that the second condition has not occurred and the alert indicates that the second condition is pending.

In some aspects, the techniques described herein relate to a system, wherein to monitor the status includes determining one or more criteria for the second condition to fulfil, and wherein the alert indicates whether the second condition has satisfied the one or more criteria.

In some aspects, the techniques described herein relate to a system, wherein the one or more criteria include a transaction amount, a transaction target date, and a transaction mode.

1. A client device, comprising:
at least one memory; and
at least one processor coupled with the at least one memory and configured to cause the client device to:
detect that a data transaction between the client device and a service provider system includes a pending resource transfer reversal condition;
monitor a status of the pending resource transfer reversal condition; and
generate an alert for display in a user interface of the client device based on the monitored status.

2. The client device of claim 1, wherein the data transaction includes an initial data exchange of a first data amount from the client device to the service provider system and the pending resource transfer reversal condition includes a subsequent data exchange of a second data amount from the service provider system to the client device, the second data amount less than the first data amount.

3. The client device of claim 1, wherein the status indicates that the resource transfer reversal condition has not occurred and the alert indicates that the resource transfer reversal condition is pending.

4. The client device of claim 1, wherein the status indicates that the resource transfer reversal condition has occurred and the alert indicates that the resource transfer reversal condition has been successfully completed.

5. The client device of claim 1, wherein to monitor the status includes determining one or more criteria for the pending resource transfer reversal condition to fulfil, and wherein the alert indicates whether the pending resource transfer reversal condition has satisfied the one or more criteria.

6. The client device of claim 5, wherein the one or more criteria include a transaction amount, a transaction target date, and a transaction mode.

7. The client device of claim 5, wherein the status indicates that one or more of the criteria have not been satisfied and the alert indicates which of the criteria have not been satisfied.

8. The client device of claim 1, wherein the client device is further configured to cease monitoring the status responsive to detection of successful completion of the resource transfer reversal condition.

9. The client device of claim 1, wherein the client device is further configured to generate a query for display in the user interface to obtain consent to monitor the status, and to monitor the status responsive to receipt of an affirmative response to the query.

10. A method performed by a client device, the method comprising:
initiating, by the client device, a data transaction between the client device and a service provider system;
detecting that the data transaction includes:
a first condition that includes an initial resource transfer from the client device to the service provider system; and
a second condition that includes a pending resource transfer from the service provider system to the client device;
monitor a status of the second condition of the data transaction; and
generate an alert for display in a user interface of the client device based on the monitored status.

11. The method of claim 10, wherein the status indicates that the pending resource transfer of the second condition has not occurred and the alert indicates that the second condition is pending.

12. The method of claim 10, wherein the status indicates that the pending resource transfer of the second condition has occurred and the alert indicates that the pending resource transfer has been successfully completed.

13. The method of claim 10, further comprising determining one or more criteria for the second condition to fulfill and wherein the alert indicates whether the pending resource transfer has satisfied the one or more criteria.

14. The method of claim 13, wherein the one or more criteria include a transaction amount, a transaction target date, and a transaction mode.

15. The method of claim 13, wherein the status indicates that one or more of the criteria have not been satisfied and the alert indicates which of the criteria have not been satisfied.

16. The method of claim 10, further comprising ceasing monitoring the status responsive to detection of successful completion of the pending resource transfer.

17. A system, comprising:
at least one memory; and
at least one processor coupled to the at least one memory and configured to cause the system to:
receive a request to initiate a data transaction between a first client device and a second client device;
detect that the data transaction includes:
a first condition that includes an initial resource transfer from the first client device to the second client device; and
a second condition that includes a pending resource transfer from the second client device to the first client device;
monitor a status of the second condition; and
generate an alert for display in a user interface of the first client device based on the monitored status.

18. The system of claim 17, wherein the status indicates that the second condition has not occurred and the alert indicates that the second condition is pending.

19. The system of claim 17, wherein to monitor the status includes determining one or more criteria for the second condition to fulfil, and wherein the alert indicates whether the second condition has satisfied the one or more criteria.

20. The system of claim 19, wherein the one or more criteria include a transaction amount, a transaction target date, and a transaction mode.
